(19) United States
(12) Patent Application Publication
(10) Pub. No.: US 2004/0142191 A1
(43) Pub. Date: Jul. 22, 2004

(54) Opaque polyimide coverlay

(75) Inventors: Wang Mei-Yen, Chunan (TW); Huang Chuan-Yi, Chunan (TW); Jiang Ying-Teh, Chunan (TW)

Correspondence Address: DENNISON, SCHULTZ, DOUGHERTY & MACDONALD, 1727 KING STREET, SUITE 105, ALEXANDRIA, VA, 22314, US

(73) Assignee: THINFLEX CORPORATION

(21) Appl. No.: 10/755,226

(22) Filed: Jan. 13, 2004

(30) Foreign Application Priority Data
Jan. 14, 2003 (TW) 092100729

(51) Int. Cl. B32B 5/16

(52) U.S. Cl. 428/473.5; 428/323

(57) ABSTRACT

The present invention relates to an opaque polyimide coverlay, which is made of a transparent protection coverfilm coating with black epoxy adhesive, wherein the opaque polyimide using a transparent and heat resistant polyimide film is used as a protection coverfilm instead of using a higher cost of black polyimide film and using a black epoxy adhesive comprising carbon black powder instead of using a common epoxy adhesive.

### FIELD OF THE INVENTION

The present invention relates to an opaque polyimide coverlay, which is made of a transparent protection coverfilm coating with black epoxy adhesive, wherein the opaque polyimide using a transparent and heat resistant polyimide film is used as a protection coverfilm instead of using a higher cost of black polyimide film and using a black epoxy adhesive comprising carbon black powder instead of using a common epoxy adhesive.

### BACKGROUND OF THE INVENTION

A coverlay is used as a protection coverfilm for protecting flexible printed circuit boards, electronic components or leadframe of integrated circuit package. The coverlay can prevent damages by protecting them from scratch, oxidation and contamination. Essentially, a coverlay comprises a polymer protection film and an adhesive layer. The commercial available coverlay further includes a releasing film. Due to the assembling steps of the mentioned products always involved high temperature process, therefore, the coverlay should use a high temperature resisting polyimide film (such as KAPTON or KANEKA) as a polymer protection coverfilm. Epoxy resin has an excellent electric resistance, mechanical strength and chemical resistance properties, and has a very good adhesion to both of polyimide film and copper foil. Therefore, the epoxy resin may be used as adhesive of the coverlay. Typically, a coverlay for flexible printed circuits consists a KAPTON film (i.e. polyimide film) and epoxy adhesive layer.

Due to the assembling steps of electronic components always involved high temperature process, therefore, the circuits should use a high temperature resisting polyimide film as a polymer protection coverfilm. There are many photoelectronic components also were employed a high temperature resisting polymer protection coverfilm to avoid to chemical corrosion caused by high temperature soldering process. Recently, a new technology trend, it may be employed a black protection coverfilm to improve the contrast proformance of the photoelectronic components. This black protection coverfilm is a non-transparent and non-reflecting coverfilm and is made of a black polyimide film (named Kapton-CB) coated with an epoxy adhesive layer. This black polyimide film (Kapton-CB) provides excellent electric properties, high temperature resistance and good adhesion.

Additional, the coverlay may be used in manufacturing of light emitting devices (such as LED) to protect the circuit board therewith. The manufacturing of light emitting components is also trying to apply an opaque coverlay to protect their circuits. The non-reflecting and non-transparent opaque coverlay provides a dark background for the light emitting device. The dark background will not reflect rear-light, therefore, an opaque coverlay may improve the contrast proformance of light emitting devices.

Although the Kapton-CB base coverlay can obtain a satified contrast effect as well as the good adhesion and protecting function. However, there still is a drawback to use the Kapton-CB polyimide film as a protective coverlayer. Because the black Kapton-CB polyimide film is a unique and special product, this black polyimide film is a relative expansive than common polyimide film and only very few of polyimide film producer can provide this black polyimide film product.

### SUMMARY OF THE INVENTION

The present invention provides an opaque polyimide coverlay, which is made of a transparent protective polyimide coverfilm carrying a black epoxy adhesive. A transparent and heat resistant polyimide film is using as a protective coverfilm instead of using an expansive black polyimide film.

The present invention provides a black epoxy resin adhesive, which is a heat resisting epoxy resin comprising inorganic fillers contained suitable amount of carbon black powder. This black epoxy resin adhesive having non-transparent and non-reflecting effects so that it can be using as adhesive for producing an opaque coverlay.

### DETAILED DESCRIPTION

The opaque polyimide coverlay of this invention is made of a polyimide film as a protective coverfilm and an epoxy resin as an adhesive layer. Particularly, the epoxy resin of this invention comprising carbon black powder as an inorganic filler to produce an epoxy resin has non-reflecting and non-transparent effects and, therefore, the polyimide coverlay is has non-reflecting and non-transparent. However, the polyimide coverfilm is not limited to select a non-reflecting and non-transparent polyimide film. Considering of the high cost of black polyimide film, the preferrable polyimide film is selected from a common polyimide film, which is transparent.

The opaque polyimide coverlay of this invention may further comprise a releasing film to prevent contamination before use. The surface of the adhesive side of this opaque polyimide coverlay may be laminated a releasing paper or PET film.

This invention relates to an opaque polyimide coverlay, which comprising a polyimide film and an epoxy adhesive layer; wherein said epoxy adhesive comprising inorganic filler of carbon black powder; wherein said epoxy adhesive comprising carbon black powder shown as an opaque layer, and said polyimide coverlay is opaque.

This invention also relates to the epoxy adhesive formulations, which comprising,

at least of 40 parts of brominated epoxy resin;

at least of 20 parts of rubber of butadiene acrylonitrile;

7.8 phr of catalyst;

0.5 phr of accelerator; and

inorganic filler;

wherein the inorganic filler comprises from 1.0 to 10.0 phr of carbon black powder.

The epoxy resin of this invention comprises at least 40 parts of brominated epoxy resin, which having good in flame retardance, and the brominated epoxy were selected from brominated bisphenol A epoxy resin, brominated bisphenol F epoxy resin. Additional, the epoxy resin further contained multifunctional epoxy resin to improve its heat resistance and chemical resistance under high temperature soldering processing.

In order to improve the flexibility of the epoxy adhesive, the epoxy resin comprises at least 20 wt % of rubber, preferrably butadiene acrylonitrile. The butadiene acrylonitrile includes carboxyl-terminated butadiene acrylonitrile (CTBN) and amine terminated butadiene acrylonitrile (ATBN).

The suitable curing agents include 3,3-diaminodiphenyl sulfone (3,3-DDS), 4,4-diaminodiphenyl sulfone (4,4-DDS) and methylene dianiline (DDM). The suitable curing catalysts include 2-methyl-imidazole (2MI), 2-ethyl-4-methyl-imidazole (2E4MZ) and 2-phenyl-imidazole (2PZ).

Inorganic filler may use for modifying several characters of the epoxy resin, including thermal conductivity, coefficient of thermal expansion and dimensional stability. However, the addition of inorganic filler also influences the processing conditions for preparing epoxy resin, therefore, this invention may select different inorganic filler and suitable amount of inorganic filler depending on the usage of result epoxy adhesive. The suitable inorganic fillers including silica oxide, mica, alumina, aluminium hydroxide, titanium oxide, talc, magnesium hydroxide, zinc carbonate and antimony trioxide. Furthermore, the epoxy resin also comprises suitale amount of carbon black powder for obtaining a non-reflecting and non-transparent effects.

In order to obtain a non-reflecting and non-transparent effect, the amount of carbon black powder should be at least 1.0 phr otherwise the resin may not non-transparent. However, the resin contained too much amount of carbon black powder may increase the viscosty. If the content of carbon black powder were more than 10.0 phr, the viscosty of the epoxy resin would be difficult to process. Theefore, the preferrably content of carbon black powder is from 1.0 to 10.0 phr, more preferrably is from 1.0 to 5.0 phr.

### EXPERIMENT

### Preparation of Butadiene Acrylonitrile-MEK Solution

Adding 840 grams of MEK to a container, then disolving 160 grams of amine terminated butadiene acrylonitrile(ATBN) to MEK to prepare a 16% ATBN-MEK solution.

### Preparation of Epoxy Adhesive Solution

### Preparation of Epoxy Adhesive without Carbon Black

### Example 1 (B-1)

An epoxy adhesive without carbon black were prepared by adding 28.77 grams of brominated epoxy resin solution (contained 65% epoxy resin commercial available product), 2.33 grams of DDS, 0.15 grams of 2MI, 5.20 grams of Al(OH)₃ powder, 0.60 grams of Talc powder and 0.60 grams of Sb₂O₃ into 69.0 grams of ATBN-MEK solution in a plastic container. The mixture of epoxy resin adhesive formulation was then subjected to high shear mixing for more than 6 hrs to mix thoroughly. The viscosity of final mixture is about 1100 cps.

### Preparation of Epoxy Adhesive Comprising Carbon Black

### Example 1 (C-1)

An epoxy adhesive without carbon black were prepared by adding 28.77 grams of brominated epoxy resin solution, 2.33 grams of DDS, 0.15 grams of 2MI, 5.20 grams of Al(OH)₃ powder, 0.60 grams of Talc powder, 0.60 grams of Sb₂O₃,and 0.10 grams of carbon black powder into 69.0 grams of ATBN-MEK solution in a plastic container. The mixture of epoxy resin adhesive formulation was then subjected to high shear mixing for more than 6 hrs to mix thoroughly.

Except the carbon black powder addition, the raw materials and the procedure for preparation of epoxy adhesive of Example 2(C-1) is same as Example 1(B-1).

### Examples C-2 to C-10

Except the amount of carbon black powder addition, the raw materials and the procedure for preparation of epoxy adhesive of Example 1 (B-1) was repeated. The amounts of carbon black powder in C-2 to C-10 were 1.0 phr to 20.0 phr respectively.

### Preparation of Polyimide Coverlay

A polyimide coverlay was prepared by coating the above-mentioned epoxy adhesive solution onto a polyimide film (Kaneka, 25 μm), forming a thin layer, and then baking in a oven with 110° C. for 4 minites, wherein the thickness of epoxy adhesive layer is about 35 μm.

### Preparation of Peel Strength Testing Specimens

Laminating above-mentioned polyimide coverlay to the surface of a 1.0 oz copper foil, and hot pressing with 170° C.-30 kg/cm²-30 min, and then obtaining a copper-polyimide laminate. The copper-polyimide laminate was cut into 15 mm×200 mm peel strength testing specimen. The peel strength of specimens were tested in accordance with IPC-2.4.9 at 50.8 mm/min.

### Results

B-1 is a comparative example of epoxy resin without carbon black powder addition. However, the peel strength testing specimens prepared from B-1 epoxy adhesive are met the reqiurement of IPC. This result implied that the blank epoxy formulation is suitable epoxy adhesive formulation for producing a polyimide coverlay.

C-1 to C-10 are epoxy resin comprise different amount of carbon black powder. Examples of C-9 and C-10 contained too much carbon black powder and resulted a very viscosty to very difficult to processing. To exam the relatiion between the amount of carbon black and peel strength, we can find that the amount of carbon black is unlikely influence to the peel strength; at least, it will not degrade the peel strenght. Finally, to exam the transparacy of the specimens, except the C-1 contained only 0.34 phr of carbon black and shown translucent, all of other examples are met the non-transparent requirement.

TABLE 1

| | B-1 | C-1 | C-2 | C-3 | C-4 | C-5 | C-6 | C-7 | C-8 | C-9 | C-10 |
|---|---|---|---|---|---|---|---|---|---|---|---|
| CB content | 0.0 | 0.34 | 1.00 | 1.67 | 2.68 | 3.69 | 5.00 | 6.70 | 10.0 | 15.0 | 20.0 |
| (phr) | | | | | | | | | | | |
| Viscosity | 1100 | 1090 | 1180 | 1360 | 1400 | 1420 | 1500 | 1850 | 2850 | >3000 | >3000 |
| (cps) | | | | | | | | | | | |
| Peel strength | 2.00 | 1.98 | 2.10 | 2.39 | 2.38 | 2.48 | 2.91 | 2.83 | 2.63 | — | — |
| (kg/cm²) | | | | | | | | | | | |
| Appearance | W | B | B | B | B | B | B | B | B | | |
| Transparence | T | T-O | O | O | O | O | O | O | O | | |

Thickness of Epoxy Adhesive: 35 μm

We claim:

1. An opaque polyimide coverlay comprising:
a polyimide film; and
An adhesive layer, wherein the adhesive is an epoxy adhesive comprises from 1.0 to 10.0 phr of carbon black powder;
wherein said epoxy adhesive comprising carbon black powder shown as an opaque layer, and said polyimide coverlay is opaque.

2. An opaque polyimide coverlay according to claim 1, wherein said polyimide film is a transparent polyimide film.

3. An opaque polyimide coverlay according to claim 1, wherein said epoxy adhesive comprises from 1.0 to 5.0 phr of carbon black powder.

4. An opaque polyimide coverlay according to claim 1, wherein said epoxy adhesive comprising:
at least of 40 parts of brominated epoxy resin;
at least of 20 parts of rubber of butadiene acrylonitrile;
7.8 phr of catalyst;
0.5 phr of accelerator; and
inorganic filler;
wherein the inorganic filler comprises from 1.0 to 10.0 phr of carbon black powder.

5. An opaque polyimide coverlay according to claim 1, wherein the surface of said adhesive layer further laminated a releasing paper.

6. An opaque epoxy adhesive used for producing polyimide coverlay, comprising:
at least of 40 parts of brominated epoxy resin;
at least of 20 parts of rubber of butadiene acrylonitrile;
7.8 phr of catalyst;
0.5 phr of accelerator; and
inorganic filler;
wherein the inorganic filler comprises from 1.0 to 10.0 phr of carbon black powder.

7. An opaque epoxy adhesive according to claim 6, wherein said inorganic filler comprises from 1.0 to 5.0 phr of carbon black powder.
